(19) United States
(12) Patent Application Publication
(10) Pub. No.: US 2016/0168907 A1
(43) Pub. Date: Jun. 16, 2016

(54) SAFETY DEVICE OF BLIND CORD

(71) Applicant: WINPLUS Co., Ltd., Chungcheongbuk-do (KR)

(72) Inventor: Tae-Woong Byun, Daejeon (KR)

(21) Appl. No.: 14/969,976

(22) Filed: Dec. 15, 2015

(30) Foreign Application Priority Data
Dec. 16, 2014 (KR) 2014-0181401

(51) Int. Cl. E06B 9/324

(52) U.S. Cl. CPC E06B 9/324

(57) ABSTRACT

Disclosed is a safety device of a blind cord. The safety device is configured to allow a blind cord to perform a normal function only when the blind cord that is used to control a position of a blind, such as the vertical or horizontal position of the blind, or an angle of the blind, is attached to a wall, whereby it is possible to prevent a safety accident, in particular, to prevent a baby or young child from being caught in the blind cord. The safety device allows a normal function of the blind cord only when a lower portion of the blind cord is locked to a wall via the housing, thereby preventing the blind cord from undesirably moving. Therefore, it is possible to prevent a safety accident, in particular, to prevent a baby or young child from being caught in the blind cord that undesirably moves.

### CROSS REFERENCE TO RELATED APPLICATION

The present application claims priority to Korean Patent Application No. KR 2014-0181401, filed Dec. 16, 2014, the entire contents of which is incorporated herein for all purposes by this reference.

### BACKGROUND OF THE INVENTION

1. Field of the Invention

The present invention generally relates to a safety device of a blind cord. More particularly, the present invention relates to a safety device of a blind cord that is configured to allow a blind cord to perform a normal function only when the blind cord used to control a position of a blind, such the vertical and horizontal position of the blind, or an angle of the blind, is attached to a wall, whereby it is possible to prevent safety accident, in particular, to prevent a baby or young child from being caught in the blind cord.

2. Description of the Related Art

Generally, a blind as an interior decoration is installed in a window or an entrance of a building, and is used to control incoming light from the outside.

There are a variety of types of blinds according to shapes, for example, roll blinds, vertical blinds, wood blinds, Roman shades, etc. These blinds are provided with blind cords used to control positions of the blinds.

However, the blind cords used to control the positions of the blinds may cause safety accidents, particularly for a baby or young child who may get the blind cords caught around his or her neck or ankle.

For instance, eight blind cord-related fatalities involving babies or young children have been reported in the U.S., and 29 children have nearly suffocated to death due to blind cords since 2001.

Accordingly, technologies to promote the prevention of safety accidents that may be caused by blind cords have been developed in Korea.

As a document of a related art, US Patent Application Publication No. 2008/0251622 discloses “looped-cord tensioner for an architectural covering”.

As shown in FIG. 1, the looped-cord tensioner according to the related art includes: a housing 40 connected to a lower portion of a looped-cord 22; a slide member 30 movably positioned within the housing 40; a spring 32 providing the slide member 30 with resilience; and an abutment member 56 positioned within the housing 40, wherein the abutment member 56 attaches the housing 40 to a wall while being locked to a holed sleeve 31 that is formed through the slide member 30.

The looped-cord tensioner according to the related art is configured such that the looped-cord 22 moves only when the slide member 30 is attached to a wall along with the housing 40, while pressing the spring 32. On the contrary, when the housing 40 is detached from a wall, the slide member 30 moves by resilience generated from the spring 32, while pressing the looped-cord 22 via saw teeth 78 of the slide member 30. Thereby, the housing 40 moves along with the looped-cord 22, and is caught in the blind.

Therefore, in order to normally manipulate the looped-cord 22, a user should use the looped-cord tensioner on condition that the housing 40 is attached to a wall, whereby it is possible to prevent safety accident that may be caused by undesirable movement of the blind cord.

However, the looped-cord tensioner of the related art is problematic in that the looped-cord 22 may undesirably move by a user's continuous manipulation due to a pressure decline, wherein the pressure decline arises because the slide member 30 presses a single portion of the looped-cord 22.

Meanwhile, as another document of the related art, U.S. Pat. No. 8,376,022 discloses “Loop cord tension device for window coverings”, wherein a holed sleeve is gripped and moved so as to attach the slide member to a wall. The loop cord tension device according to the related art is problematic in that it is difficult to grip the holed sleeve, which makes it difficult to attach the slide member to a wall.

Documents of Related Art

(Patent Document 1) US Patent Application Publication No 2008/0251622

(Patent Document 2) U.S. Pat. No. 8,376,022

### SUMMARY OF THE INVENTION

Accordingly, the present invention has been made keeping in mind the above problems occurring in the related art, and the present invention is intended to propose a safety device of a blind cord that is configured to allow a blind cord to perform a normal function only when the blind cord is attached to a wall, whereby it is possible to prevent a safety accident, in particular, to prevent a baby or young child from being caught in the blind cord.

To be more specific, the present invention is intended to propose a safety device of a blind cord that is configured to allow a blind cord to perform a normal function only when a housing, which is connected to a lower portion of the blind cord, is attached to a wall. In addition, the housing moves along with the blind cord when the housing is detached from the wall. Thus, it is possible to help a user to recognize whether the blind cord is safe, and thereby to induce the user to lock the blind cord to the wall.

In particular, the present invention is intended to propose a safety device of a blind cord that is configured such that the more strongly the blind cord is pulled, the more firmly the blind cord is locked while the housing is detached from a wall. Further, it is possible to easily grip and tow a portion of a pressure slider.

In order to achieve the above object, according to one aspect of the present invention, there is provided a safety device of a blind cord according to the present invention, wherein the blind cord is in a loop shape and is configured to control the position of a blind while moving by a user's manipulation, and the safety device is configured to prevent the blind cord from undesirably moving. The safety device includes: a housing configured to accommodate a portion of the blind cord and coupled to a lower part of the blind cord such that the housing allows a change of a moving direction of the blind cord, wherein movement of the blind cord is possible only when the housing is attached to a wall, and when the housing is detached from the wall, the housing is locked to a portion of the blind cord and moves along with the blind cord, and is caught by an upper part of the blind; a pressure slider movably provided in the housing; a resilient member provided in the housing, and providing resilience by elastic deformation caused by movement of the pressure slider or the housing; an attachment unit for attaching the pressure slider or the housing to a wall in a state of the resilient member being elastically deformed by movement of the pressure slider or the housing; and a locking unit provided in the housing, wherein the locking unit movably connects the pressure slider to the housing by means of the resilient member, provides an accommodation space for accommodating a portion of the blind cord in the housing, and locks the blind cord to the housing while simultaneously pressing a plurality of parts of the blind cord via movement of the pressure slider or the housing by the resilience of the resilient member when the pressure slider or the housing is detached from a wall.

For example, the pressure slider may include: a bar-shaped slider main body movably provided in the housing; and a channel-shaped spring holder formed along a longitudinal direction of the slider main body, wherein the spring holder accommodates the resilient member and supports a first end of the resilient member. In addition, the housing may include a spring protrusion protruding toward the spring holder and supporting a second end of the resilient member, wherein the spring protrusion elastically deforms the resilient member in cooperation with the spring holder in response to movement of the slider main body or the housing.

For example, the attachment unit may include: a longitudinal guide slot provided in the housing and guiding movement of the pressure slider while exposing a portion of the pressure slider; a tubular towing sleeve being a part of the pressure slider that is exposed via the guide slot, wherein the towing sleeve forms a locking part that is locked to a wall, and provides a towing part for moving the pressure slider; and a locking bolt locked to the wall while penetrating through the towing sleeve.

Further, the guide slot may include a guide hole for gripping, wherein the guide hole is provided by expanding a first end of the guide slot, and provides a gripping space along a circumference of the towing sleeve.

On the contrary, the attachment unit may include: a bolt hole provided on a lower part of the housing, wherein the bolt hole forms a locking part that is locked to a wall; and a locking bolt locked to the wall while penetrating through the bolt hole.

In addition, the attachment unit may further include a bracket that is integrally locked to the wall, and is provided with a locking hole so as to provide the locking part for locking the locking bolt.

For example, the locking unit may include: a slider rail provided in the housing, wherein the slider rail provides an accommodation space for both the resilient member and the pressure slider, and provides a moving path for allowing the pressure slider to move; a channel-shaped rail provided along an edge of the slider rail and accommodating a portion of the blind cord while allowing the blind cord to be pulled, wherein an end of the channel-shaped rail communicates with the slider rail so that an end of the pressure slider can move in and out of the end of the channel-shaped rail in response to movement of the pressure slider; and a pressing guard provided on each of opposed sides of the end of the channel-shaped rail by protruding so as to make a width between the opposed sides of the end of the channel-shaped rail narrow, wherein the pressing guard presses and locks the blind cord in cooperation with the end of the pressure slider in response to movement of the pressure slider.

In addition, the locking unit may further include a wedge-shaped pressing protrusion provided on each of opposite sides of the end of the pressure slider by protruding, wherein the pressing protrusion presses and locks the blind cord in cooperation with the pressing guard by closely contacting with the blind cord.

Herein, the pressing protrusion may be configured such that as the blind cord is continuously pulled with the blind cord pressurized by both the pressing guard and the pressing protrusion, the pressing protrusion clamps the blind cord. Thus, it is possible to prevent the blind cord from moving.

The above-mentioned safety device of a blind cord according to the present invention is advantageous in that the safety device allows a normal manipulation of the blind cord only when a lower portion of the blind cord is locked to a wall via the housing, thereby preventing the blind cord from undesirably moving. Therefore, it is possible to prevent a safety accident, in particular, to prevent a baby or young child from being caught in the blind cord that undesirably moves.

To be more specific, when the housing is detached from a wall, the pressure slider or the housing moves along the slider rail that forms the locking unit by resilience generated from the resilient member. Here, an end of the pressure slider protrudes toward a narrow portion of the channel-shaped rail, and presses the blind cord in cooperation with the pressing guard. Thus, it is possible to lock the housing to the blind cord firmly.

Further, the attachment unit according to the present invention may have a variety of configurations, wherein the attachment unit is used to attach the housing to a wall. For example, the attachment unit may be configured to move the pressure slider or to move the housing so as to attach the housing to a wall.

Herein, according to the present invention, when the attachment unit is configured to move the pressure slider so as to attach the housing to a wall, the attachment unit moves and locks the towing sleeve of the pressure slider so as to attach the housing to the wall. Thereby, resilience is generated from the resilient member, and the blind cord remains tight, thus preventing a safety accident, for example, preventing a baby or young child from being caught in the blind cord that undesirably moves.

Further, the safety device according to the present invention allows the towing sleeve to be gripped with ease by the guide hole for gripping that is provided in an end of the guide slot. Thus, it is possible to move and attach the pressure slider to a wall with ease.

Meanwhile, according to the present invention, when the attachment unit is configured to move the housing itself so as to attach the housing to a wall, the guide slot provided in the housing and the towing sleeve provided in the pressure slider may be omitted. Thus, it is possible to make the shape of the housing simple.

Further, when there is provided the bracket that provides the locking part for locking the locking bolt, it is easy to attach the housing to a variety of walls.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view of the related art;

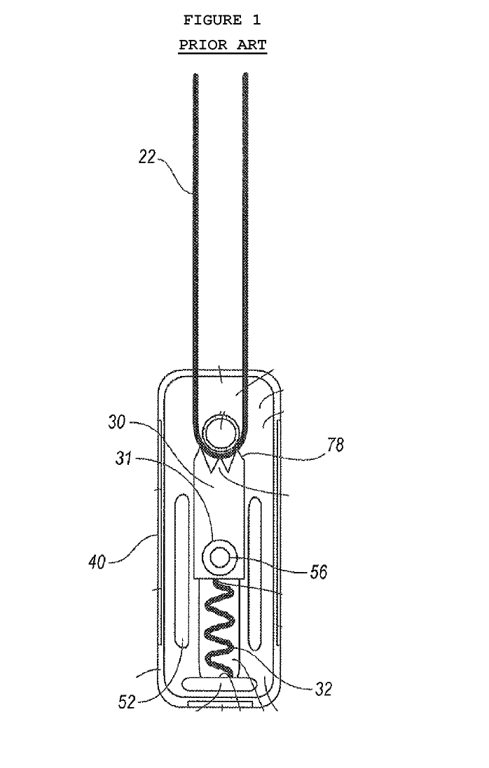

FIG. 2 is a perspective view of a safety device of a blind cord according to a first embodiment of the present invention;

FIG. 3 is an exploded perspective view showing overall configuration of the safety device of a blind cord according to the first embodiment of the present invention;

FIG. 4 is an exploded perspective view showing overall configuration of the safety device of a blind cord according to the first embodiment of the present invention;

FIG. 5 is a front view showing a state where a housing according to the first embodiment of the present invention is detached from a wall;

FIG. 6 is a front view showing a state where the housing according to the first embodiment of the present invention is attached to a wall;

FIG. 7 is a front view showing a state where a housing according to a second embodiment of the present invention is detached from a wall;

FIG. 8 is a front view showing a state where the housing according to the second embodiment of the present invention is attached to the wall; and

FIG. 9 is a perspective view showing an attachment unit according to a modification of the embodiments of the present invention.

### DETAILED DESCRIPTION OF THE INVENTION

Exemplary embodiments of the present invention will be described more fully hereinafter with reference to the accompanying drawings. In the following description of the present invention, detailed descriptions of known functions and components incorporated herein will be omitted when it may make the subject matter of the present invention unclear.

Reference will now be made in detail to various embodiments of the present invention, specific examples of which are illustrated in the accompanying drawings and described below, since the embodiments of the present invention can be variously modified in many different forms. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to”, or “directly adjacent to” should be construed in the same way.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

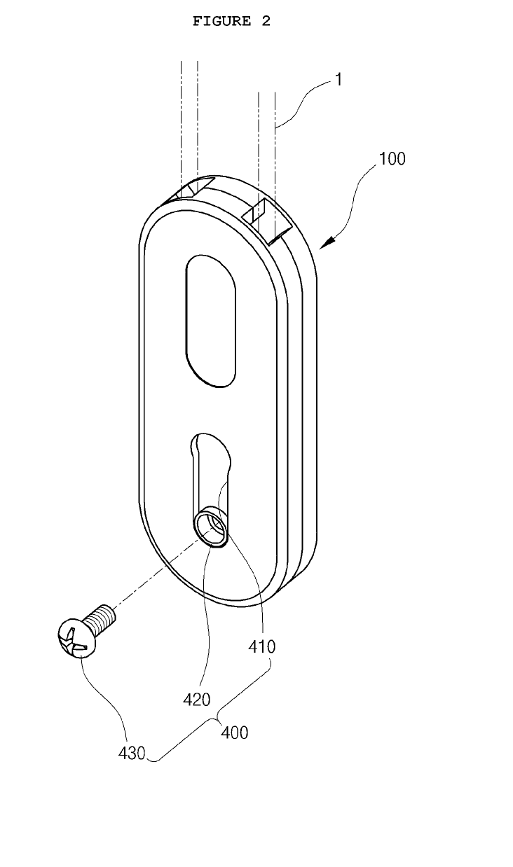

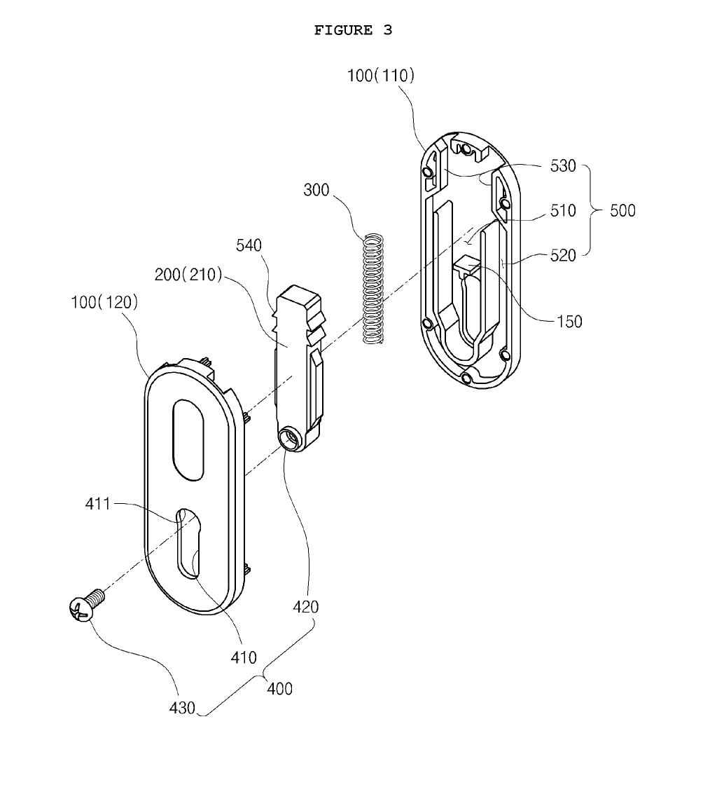

A safety device of a blind cord according to the present invention is applied to a blind cord that is used to control a position of a blind, such as the vertical and horizontal position of the blind, or an angle of the blind, wherein the blind cord is provided to a variety of blinds, such as roll blinds, vertical blinds, wood blinds, roman shades, etc. As shown in FIGS. 2 and 3, the safety device of a blind cord according to the present invention may include a housing 100, a pressure slider 200, a resilient member 300, an attachment unit 400, and a locking unit 500.

Herein, the blind cord 1 extends in a lower direction of the blind, becoming in a looped shape, wherein the blind cord 1 may be in a variety of shapes, such as a loop or a ball shape.

As shown in FIG. 2, the housing 100 is configured to accommodate a portion of the blind cord 1, and is coupled to a lower part of the blind cord 1 that is in a loop shape, wherein normal movement of the blind cord 1 is possible only when the housing 100 is attached to a wall, and when the housing 100 is detached from a wall, the housing 100 is locked to the blind cord 1 via a configuration mentioned hereinafter.

While the housing 100 is detached from a wall, the housing is locked to the blind cord 1 and moves along with the blind cord 1, and thereby is caught by a structure that forms the blind and is not shown in drawings.

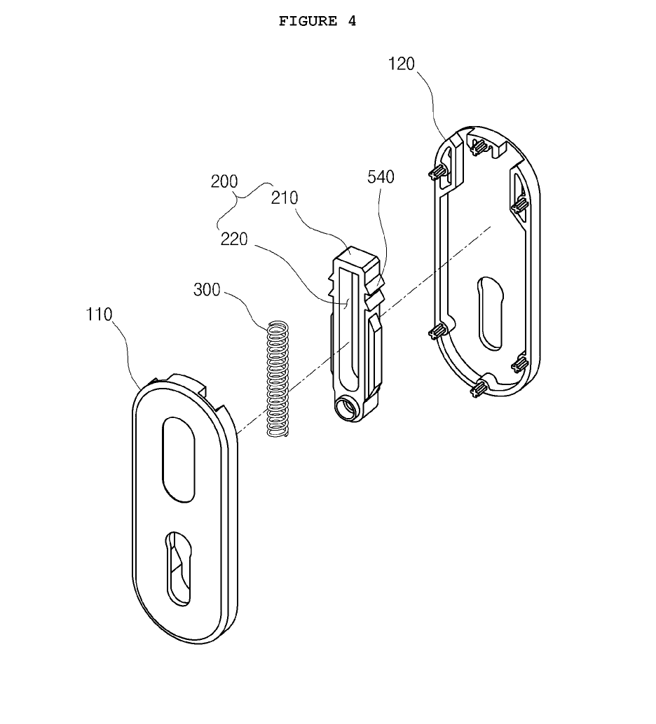

The housing 100 may further include, for example, a housing main body 110 and the housing cover 120, as shown in FIGS. 3 and 4.

As shown in FIG. 3, the case-shaped housing main body 110 has an open end thereof, wherein elements mentioned hereinafter are formed or accommodated therein.

As shown in FIG. 3, the housing cover 120 covers the open end of the housing main body 110, and accommodates a lower part of the blind cord 1 in the housing main body 110.

Herein, as shown in FIG. 4, the housing cover 120 may be provided with a locking protrusion along the edge thereof so as to be coupled to the housing main body 110 in a manner of a snap, on the contrary the housing cover 120 may be coupled to the housing main body 110 via an additional attachment member, such as an attachment bolt.

The pressure slider 200 is movably provided in the housing 100. While the housing 100 is detached from a wall, the housing moves, and presses both a portion of the housing 100 and a portion of the blind cord 1. Thus, the pressure slider 200 locks the housing 100 to the blind cord 1.

As shown in FIG. 4, the pressure slider 200 may include the slider main body 210 and the spring holder 220.

As shown in FIG. 3, the bar-shaped slider main body 210 is movably provided in a slider rail 510 mentioned hereinafter that is provided in the housing 100.

As shown in FIG. 4, the channel-shaped spring holder 220 is formed along a longitudinal direction of the slider main body 210, and accommodates a resilient member 300 mentioned hereinafter.

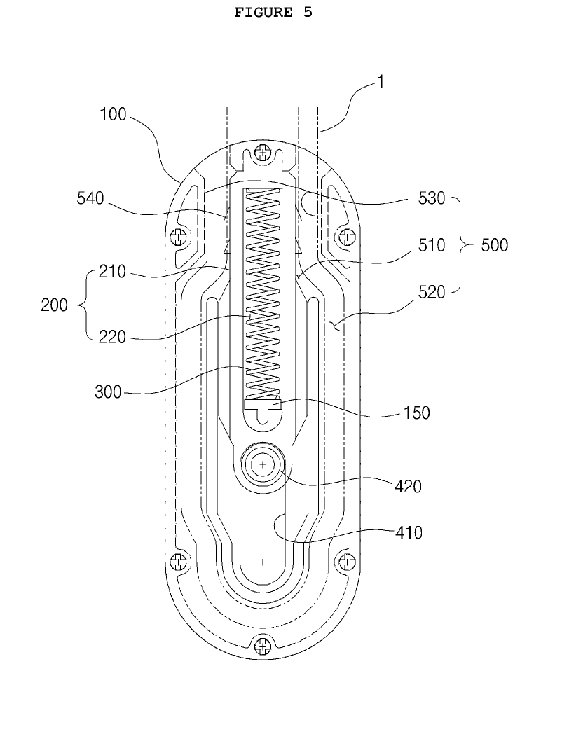

As shown in FIG. 5, the spring holder 220 accommodates the resilient member 300, and supports a first end of the resilient member 300.

Meanwhile, as shown in FIG. 3, the housing 100 has a spring protrusion 150. The spring protrusion 150 protrudes toward the spring holder 220, and supports a second end of the resilient member 300 as shown in FIG. 5.

The resilient member 300 along with the pressure slider 200 is mounted to a slider rail 510 in a state where the resilient member 300 is accommodated in the spring holder 220 that is provided in the pressure slider 200. Each end of resilient member 300 is supported by an end of the spring holder 220 and the spring protrusion 150, respectively.

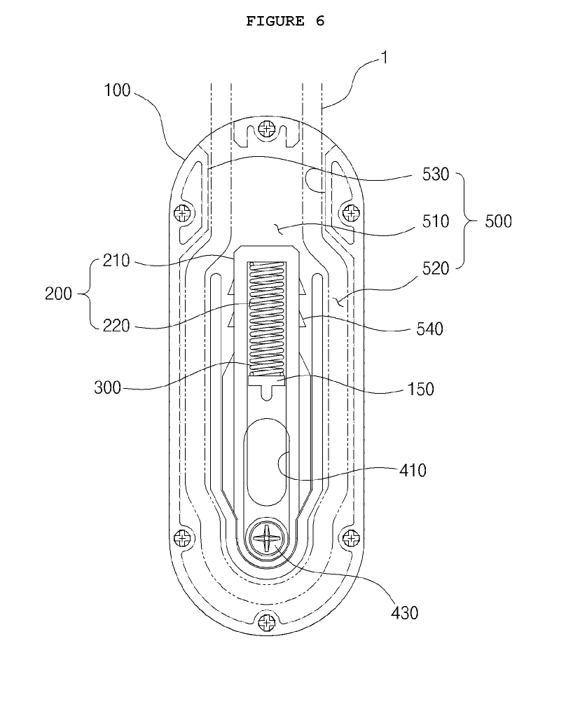

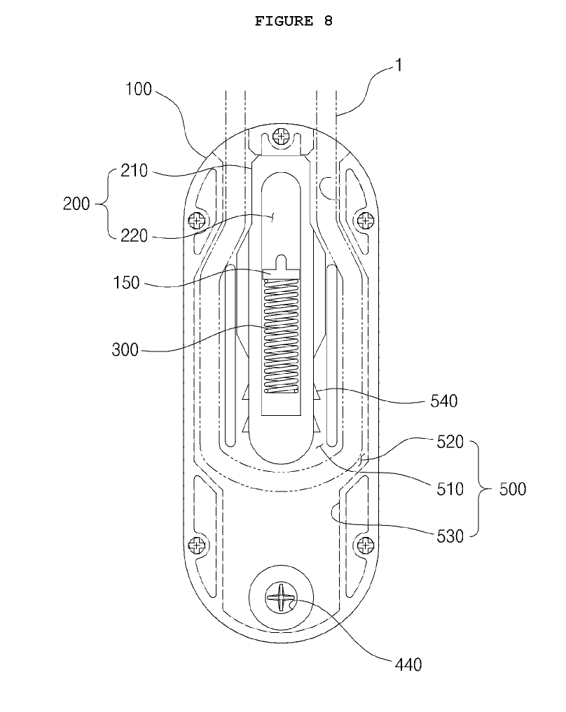

Further, as shown in FIGS. 6 and 8, the resilient member 300 provides resilience via elastic deformation by the spring protrusion 150 in response to movement of the pressure slider 200 or the housing 100. When the housing 100 is detached from a wall, the resilient member 300 is restored by the resilience, and provides pressure for pressing the blind cord 1.

According to a first embodiment of the present invention, the resilient member 300 is a compression coil spring. However, the resilient member 300 may be a tension coil spring or a spiral spring so as to provide resilience via movement of the pressure slider 200 or the housing 100.

Meanwhile, as shown in FIG. 4, the pressure slider 200 according to the first embodiment of the present invention may include a towing sleeve 420 mentioned hereinafter that is provided in a lower part of the slider main body 210. Thereby, as shown in FIGS. 5 and 6, the slider main body 210 can move.

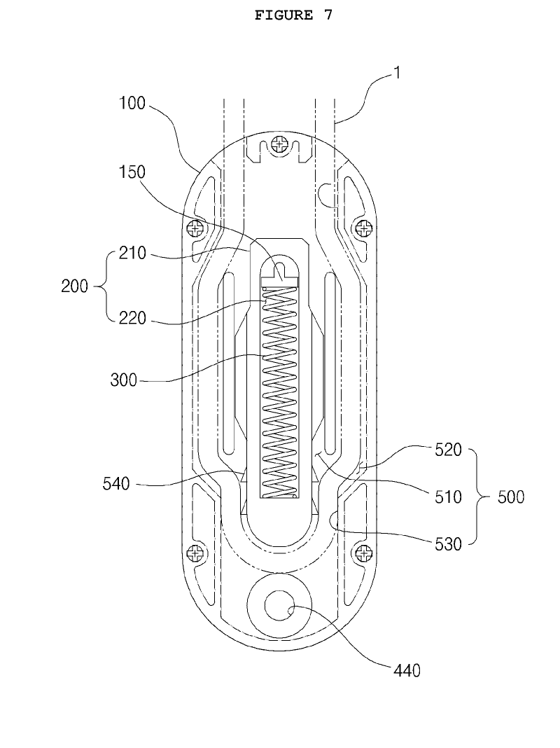

Further, as shown in FIGS. 7 and 8, the pressure slider 200 according to a second embodiment of the present invention may be configured such that the housing 100 moves without the towing sleeve 420.

The attachment unit 400 attaches the pressure slider 200 or the housing 100 to a wall in the state where the resilient member 300 is pressed via movement of the pressure slider 200 or the housing 100 as mentioned hereinbefore.

For example, as shown in FIG. 3, the attachment unit 400 according to the first embodiment of the present invention may include a guide slot 410, the towing sleeve 420, and a locking bolt 430.

As shown in FIG. 3, the longitudinal guide slot 410 is provided in the housing 100, and guides movement of the towing sleeve 420 provided in the pressure slider 200, exposing the towing sleeve 420.

As shown in FIG. 3, the tubular towing sleeve 420 penetrates through a lower part of the pressure slider 200, and is exposed via the guide slot 410.

The towing sleeve 420 provides a towing part for moving the pressure slider 200, and forms a locking part that is locked to a wall.

Meanwhile, as shown in FIG. 3, the guide slot 410 may include a guide hole for gripping 411. The guide hole for gripping 411 is provided by expanding a first end of the guide slot 410, and helps to grip the towing sleeve 420.

In other words, the guide hole for gripping 411 is provided by expanding a first end of the guide slot 410, and is apart from a circumference of the towing sleeve 420. Thereby, the guide hole for gripping 411 provides a gripping space along the circumference of the towing sleeve 420, allowing the towing sleeve 420 to be gripped and be towed with ease.

As shown in FIG. 2, as the locking bolt 430 is locked to a wall while penetrating through the towing sleeve 420, the locking bolt 430 locks both the pressure slider 200 and the housing 100 to the wall.

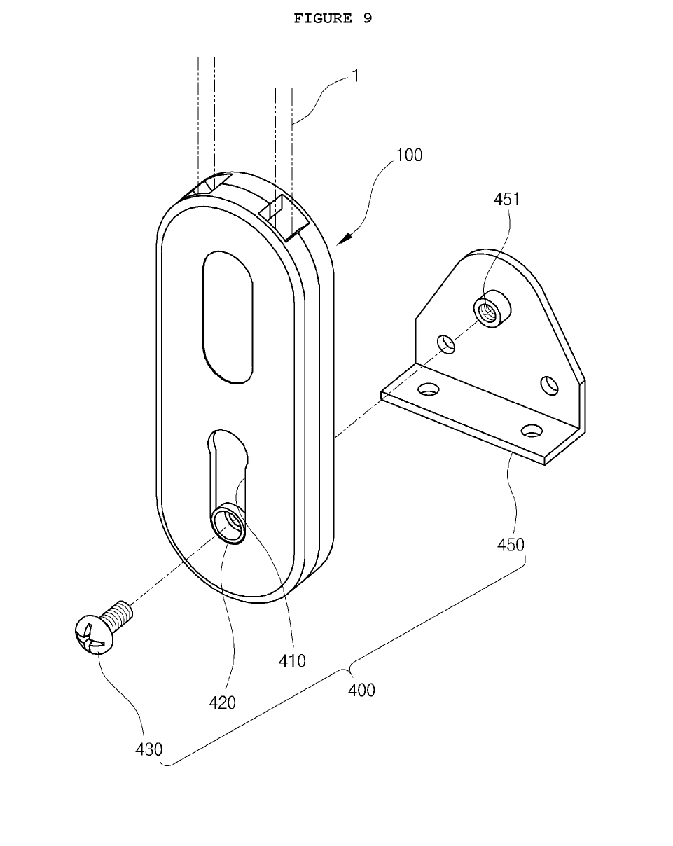

Meanwhile, as shown in FIG. 9, the attachment unit 400 may further include a bracket 450 that is integrally locked to a wall or a window frame.

The bracket 450 provides the locking part for locking the locking bolt 430 when difficulty in locking the locking bolt 430 directly to a wall occurs due to a shape of a wall.

As shown in FIG. 9, the bracket 450 may be integrally locked to a wall or a ground surface, and be in an angular shape, wherein the bracket 450 is provided with a locking hole 451 where the locking bolt 430 is locked.

Herein, as shown in FIG. 9, a portion of the bracket 450, where the locking hole 451 is provided, protrudes in a boss shape so that the locking hole 451 can be inserted in and be connected to the towing sleeve 420.

Thus, it is easy to connect the towing sleeve 420 by the locking bolt 430 in a state where the towing sleeve 420 is temporarily connected to the bracket 450 through the boss-shaped locking hole 451.

Meanwhile, as shown in FIGS. 7 and 8, the attachment unit 400 according to the second embodiment of the present invention may include a bolt hole 440 and a locking bolt 430 provided in the housing 100, without the guide slot 410 and the towing sleeve 420.

A locking unit 500 is provided in the housing 100, movably accommodates the pressure slider 200 along with the resilient member 300, and provides an accommodation space for accommodating a portion of the blind cord 1 in the housing 100. In addition, the locking unit 500 locks a portion of the blind cord 1 to the housing 100 via resilience of the resilient member 300 when the housing 100 is detached from a wall.

As shown in FIG. 3, the locking unit 500 may include a slider rail 510, a channel-shaped rail 520, and a pressing guard 530.

As shown in FIGS. 3 and 5, the slider rail 510 is vertically formed at a center of the housing main body 110 of the housing 100, and movably accommodates the pressure slider 200.

As shown in FIGS. 3 and 5, the channel-shaped rail 520 is provided along an edge of the slider rail 510 in the housing main body 110, and accommodates a portion of the blind cord 1 while allowing the blind cord 1 to be pulled.

An end of the channel-shaped rail 520 communicates with the slider rail 510 such that an end of the pressure slider 200 moves in and out of a communicated portion.

In other words, according to the first embodiment of the present invention, an upper end of the channel-shaped rail 520 communicates with the slider rail 510, and thus an upper end of the pressure slider 200 moves in and out of a communicated portion, as shown in FIG. 5. By contrast, according to the second embodiment of the present invention, a lower end of the channel-shaped rail 520 communicates with the slider rail 510, and thus a lower end of the pressure slider 200 moves in and out of a communicated portion, as shown in FIG. 7.

A pressing guard 530 is provided on each of opposed sides of the end of the channel-shaped rail 520, namely a portion where an end of the pressure slider 200 moves in and out, by protruding so as to make a width between the opposed sides of the end of the channel-shaped rail 520 narrow. The pressing guard 530 presses and locks the blind cord 1 in cooperation with the end of the pressure slider 200.

In other words, as shown in FIGS. 5 and 7, when the housing 100 is detached from a wall, the pressing guard 530 presses the blind cord 1 in cooperation with the end of the pressure slider 200 that protrudes toward a center, and thereby locks the housing 100 to the blind cord 1.

Herein, as shown in FIGS. 5 and 7, the pressure slider 510 may be provided with a wedge-shaped pressing protrusion 540 on each of opposite sides of the end of the pressure slider 510 by protruding so as to lock the blind cord 1 more securely.

In particular, the more a user pulls the blind cord 1 while the pressing protrusion 540 presses the blind cord 1 in cooperation with the pressing guard 530, the more firmly the pressing protrusion 540 presses and locks the blind cord 1 by clamping the blind cord 1, wherein the blind cord 1 is prone to reversely move within the hosing 100. Thus, it is possible to prevent the blind cord 1 from moving.

Reference will hereinafter be made on operation of the present invention configured by above description.

Firstly, reference will hereinafter be made on operation according to the first embodiment of the present invention, as shown in FIGS. 5 and 6.

As the pressure slider 200 is towed by the towing sleeve 420 and moves along the guide slot 410, the housing 100 is attached and locked to a wall via the locking bolt 430.

Here, the pressure slider 200 moves, pressing the resilient member 300 in cooperation with the spring protrusion 150. Herein, an upper end of the pressure slider 200 is apart from a portion where the pressing guard 530 on the channel-shaped rail 520 protrudes, allowing the blind cord 1 to move.

Meanwhile, the pressure slider 200 moves upward by resilience of the resilient member 300 while the housing 100 is detached from a wall. Thereby, the pressure slider 200 presses the blind cord 1 in cooperation with the pressing guard 530, and locks the housing 100 to the blind cord 1.

Secondly, reference will hereinafter be made on operation according to the second embodiment of the present invention, as shown in FIGS. 7 and 8.

The housing 100 is pulled downward by a user's manipulation, pressing the resilient member 300 via the spring protrusion 150. And then, when the locking bolt 430 is locked to the bolt hole 440, the housing 100 is attached to a wall.

Here, the pressure slider 200 presses the resilient member 300 in cooperation with the spring protrusion 150, and a lower end of the pressure slider 200 is apart from a portion where the pressing guard 530 on the channel-shaped rail 520 protrudes, allowing the blind cord 1 to move.

Meanwhile, the housing 100 moves upward by resilience of the resilient member 300 when the housing 100 is detached from a wall. Thereby, a lower end of the pressure slider 200 presses the blind cord 1 in cooperation with the pressing guard 530, and locks the housing 100 to the blind cord 1.

As described hereinbefore, the safety device of a blind cord according to the present invention allows a normal function of the blind cord only when a lower portion of the blind cord 1 is locked to a wall via the housing 100, thereby preventing the blind cord 1 from undesirably moving. Therefore, it is possible to prevent a safety accident, in particular, to prevent a baby or young child from being caught in the blind cord 1 that undesirably moves.

To be more specific, while the housing 100 is detached from a wall, the pressure slider 200 or the housing 100 moves along the slider rail 510 that forms the locking unit 500. Thereby, an end of the pressure slider 200 protrudes toward a narrow portion of the channel-shaped rail 520, and presses the blind cord 1 in cooperation with the pressing guard 530. Thus, it is possible to lock the housing 100 to the blind cord 1 smoothly.

Further, the attachment unit 400 according to the present invention may have a variety of configurations, wherein the attachment unit 400 is used to attach the housing 100 to a wall. For example, the attachment unit 400 may be configured to move the pressure slider 200 or to move the housing 100 itself so as to attach the housing 100 to a wall.

Herein, according to the present invention, when the attachment unit 400 is configured to move the pressure slider 200 so as to attach the housing 100 to a wall, the attachment unit 400 moves and locks the towing sleeve 420 of the pressure slider 200 so as to attach the housing 100 to a wall. Thereby, resilience is generated from the resilient member 300, and the blind cord 1 remains tight, thus preventing a safety accident, for example, preventing a baby or young child from being caught in the blind cord 1 that undesirably moves.

Further, according to the present invention, when the attachment unit 400 is configured to move the housing 100 itself so as to attach the housing 100 to a wall, the guide slot 410 provided in the housing 100 and the towing sleeve 420 provided in the pressure slider 200 may be left out. Thus, it is possible to make a shape of the housing 100 simple.

Although an embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A safety device of a blind cord, the blind cord being in a loop shape and being configured to control condition of a blind while moving by a user's manipulation, and the safety device being configured to prevent the blind cord from undesirably moving, the safety device comprising:
a housing configured to accommodate a portion of the blind cord and coupled to a lower part of the blind cord such that the housing allows a change of a moving direction of the blind cord, wherein while the housing is attached to a wall, the housing allows movement of the blind cord, and while the housing is detached from a wall, the housing is locked to a portion of the blind cord and moves along with the blind cord, and is caught by an upper part of the blind;
a pressure slider movably provided in the housing;
a resilient member provided in the housing, and providing resilience by elastic deformation caused by movement of the pressure slider or the housing;
an attachment unit for attaching the pressure slider or the housing to the wall in a state of the resilient member elastically deformed by movement of the pressure slider or the housing; and
a locking unit provided in the housing and functioning to movably connect the pressure slider to the housing by means of the resilient member and to provide an accommodation space for accommodating a portion of the blind cord in the housing, and to lock the blind cord to the housing while simultaneously pressing a plurality of parts of the blind cord via movement of the pressure slider or the housing by the resilience of the resilient member when the pressure slider or the housing is detached from the wall.

2. The safety device of claim 1, wherein
the pressure slider comprises:
a bar-shaped slider main body movably provided in the housing; and
a channel-shaped spring holder formed along a longitudinal direction of the slider main body, the spring holder accommodating the resilient member and supporting a first end of the resilient member, and
the housing comprises:
a spring protrusion protruding toward the spring holder and supporting a second end of the resilient member, the spring protrusion elastically deforming the resilient member in cooperation with the spring holder in response to movement of the slider main body or the housing.

3. The safety device of claim 1, wherein the attachment unit comprises:
a longitudinal guide slot provided in the housing and guiding movement of the pressure slider while exposing a portion of the pressure slider;
a tubular towing sleeve being a part of the pressure slider that is exposed via the guide slot, the towing sleeve forming a locking part that is locked to the wall and providing a towing part for moving the pressure slider; and
a locking bolt locked to the wall while penetrating through the towing sleeve.

4. The safety device of claim 3, wherein the guide slot comprises:
a guide hole for gripping, the guide hole being provided by expanding a first end of the guide slot and providing a gripping space along a circumference of the towing sleeve.

5. The safety device of claim 1, wherein the attachment unit comprises:
a bolt hole provided on a lower part of the housing, and forming a locking part that is locked to the wall; and
a locking bolt locked to the wall while penetrating through the bolt hole.

6. The safety device of claim 3 wherein the attachment unit further comprises:
a bracket integrally locked to the wall, and provided with a locking hole so as to provide the locking part for locking the locking bolt.

7. The safety device of claim 1, wherein the locking unit comprises:
a slider rail provided in the housing, and providing an accommodation space for both the resilient member and the pressure slider, and providing a moving path for allowing the pressure slider to move;
a channel-shaped rail provided along an edge of the slider rail and accommodating a portion of the blind cord while allowing the blind cord to be pulled, wherein an end of the channel-shaped rail communicates with the slider rail so that an end of the pressure slider can move in and out of the end of the channel-shaped rail in response to movement of the pressure slider; and
a pressing guard provided on each of opposed sides of the end of the channel-shaped rail by protruding so as to make a width between the opposed sides of the end of the channel-shaped rail narrow, the pressing guard pressing and locking the blind cord in cooperation with the end of the pressure slider in response to movement of the pressure slider.

8. The safety device of claim 7, wherein the locking unit further comprises:
a wedge-shaped pressing protrusion provided on each of opposite sides of the end of the pressure slider by protruding, the pressing protrusion pressing and locking the blind cord in cooperation with the pressing guard by closely contacting with the blind cord.

9. The safety device of claim 8, wherein the pressing protrusion is configured such that as the blind cord is continuously pulled with the blind cord pressurized by both the pressing guard and the pressing protrusion, the pressing protrusion bites the blind cord, thereby preventing the blind cord from moving.

10. The safety device of claim 5 wherein the attachment unit further comprises:
a bracket integrally locked to the wall, and provided with a locking hole so as to provide the locking part for locking the locking bolt.
